(19) United States
(12) Patent Application Publication
(10) Pub. No.: US 2008/0024353 A1
(43) Pub. Date: Jan. 31, 2008

(54) Radar Sensor and Method for Its Operation

(75) Inventor: Martin Schneider, Hildesheim (DE)

Correspondence Address: KENYON & KENYON LLP, ONE BROADWAY, NEW YORK, NY, 10004, US

(73) Assignee: ROBERT BOSCH GMBH, D-70442 STUTTGART GERMAY (DE)

(21) Appl. No.: 10/583,244

(22) PCT Filed: Nov. 8, 2004
(86) PCT No.: PCT/EP04/52866

§ 371 Date: May 9, 2007

(30) Foreign Application Priority Data
Dec. 19, 2003 (DE) 103-60-890.7

(51) Int. Cl. G01S 13/93

(52) U.S. Cl. 342/70; 701/223; 701/301

(57) ABSTRACT

In a radar sensor for a motor vehicle having a transmitting device and a receiving device, an adaptation of the sensor characteristic is achieved while a vehicle is operated in that transmitting parameters of the transmitting device and receiving parameters of the receiving device are variable.

### FIELD OF THE INVENTION

The present invention is based on a radar sensor.

### BACKGROUND OF THE INVENTION

Current long range radar sensors for detecting objects using radar are designed to detect targets at distances of up to 150 meters. For this purpose, highly focusing antennas must be used, which e.g. according to the laws of optics emit the high-frequency energy into a narrow space region using a focusing lens and, following the reflection by objects, receive it again only from this narrow space region. The azimuthal locating field of current radar sensors amounts to about plus/minus four to plus/minus eight degrees. In addition there are also radar sensors whose antenna characteristic over an azimuthal angle is increased by swiveling the antenna itself. Outside of the azimuthal angular range, within which the antenna is able to transmit and receive, no targets are detected. Transmitting capacity, locating field, signal generation, modulation and information evaluation are implemented in a fixed manner and are not variable. Particularly disadvantageous is the fact that the sensor characteristic cannot be adjusted while a vehicle is in operation.

### SUMMARY OF THE INVNETION

It is an object of the present invention to provide a radar sensor and a method for operating the radar sensor which avoid the above-mentioned disadvantages. This problem is solved by a radar sensor and a method for controlling the transmitting and receiving parameters of a radar sensor. The radar sensor according to the present invention for a motor vehicle having a transmitting device and a receiving device provides for transmitting parameters of the transmitting devices and receiving parameters of the receiving device to be variable. This variation, or adaptation, is to be controlled by certain events, situations or as a function of a function selected by the driver. The selected function, for example, may be a driver assistance function such as a parking assistance, an aid to starting from rest or the like. This allows for an adaptive adjustment of the locating field of a radar sensor and its resolution with respect to targets to be detected in their respective lateral positions, i.e. a distance and in an angular position as well as with respect to the relative speed. Resolution in this context means the ability to distinguish between individual targets.

A further development of the radar sensor according to the present invention provides for the transmitting parameters to be the transmitting frequency and/or the transmitting capacity and/or the modulation amplitude and/or the azimuthal width of the emitted field. A further development additionally provides for the receiving parameters to be the receiving frequency and/or the receiving sensitivity and/or the azimuthal width of the received field. The adaptation or configuration allows for such a sensor to be used in a very universal manner for tasks of the short-range sensor system in the range of 0-14 meters at a very wide azimuthal coverage of e.g. plus/minus 50 degrees as well as for tasks at medium ranges up to 40 meters and an azimuthal coverage of plus/minus 20 degrees as well as for long-range detection above a range of 40 meters at an azimuthal coverage of plus/minus 8 degrees. The adaptation of the sensor occurs both by changing the azimuthal width of the locating field as well as in relation to the respectively required distance and speed resolution. Distance resolution ensures that as the distance between the targets and the sensor decreases the resolution always becomes more precise. In the short range of the vehicle, distance resolutions in the centimeter range are required, while in the long range a resolution of approximately only one meter is required.

The method according to the present invention for controlling the transmitting and receiving parameters of a radar sensor provides for transmitting parameters and/or receiving parameters to be changed as a function of the driving condition of the vehicle. The change of the transmitting and receiving parameters may concern the antenna itself or the generation of the transmitting signal or the processing of the received signal on an analog or digital basis. The driving condition is the speed, the direction, the location as well as the execution of possible special functions such as, for example, an aid to starting from rest or the like. Preferably at least the speed and/or an assistance function selected by the driver and/or the position of the vehicle and/or the installation location of the radar sensor in the vehicle enter into the driving condition. A further development of the method provides for the speed resolution of the radar sensor to be changed. This may be done e.g. by increasing the observation time in the form of an adaptive elongation of a frequency ramp in the FMCW method or by increasing the sampling rate in the case of a pulse radar.

A further development of the method according to the present invention provides for the distance resolution of the radar sensor to be changed. This may be done e.g. by a resolution increase in the short range by increasing the frequency deviation in an FMCW radar or by a variation of the pulse length in a pulse radar.

A further development of the method according to the present invention provides for the width and shape of the antenna characteristic to be changed. This may be done by switching the elements at the high-frequency level or by digital processing in the baseband, for example in the form of digital beam shaping by complex-valued weighting of the baseband signals of individual antenna slots.

A universally usable radar sensor that works adaptively in accordance with the present invention allows for the vehicle surroundings to be sensed both in the short range and up to the long range and thus allows for a vehicle detection up to 150 meters. For achieving the objectives of the panoramic radar view, this requires only one sensor architecture in a unified technology such that the economy of a panoramic view sensor system can be maximized. The advantage of the present invention lies in the fact that the configuration or adaptation of the sensor may occur as a function of certain vehicle situations or of functions selected by the driver. The frontend is suitably implemented in 77 GHz technology or at even higher frequencies.

### DETAILED DESCRIPTION

The sensing of the vehicle surroundings fundamentally depends on the situation of the vehicle. The vehicle's own speed, position, direction of travel, the way in which the surroundings of the vehicle are interpreted or which special function, for example driver assistance functions, the driver has currently selected enter into the driving condition of the vehicle. If the vehicle's own speed, for example, is lower than 50 km/h, for example, then it is not necessary for a sensor to detect targets at 150 meters since these are then irrelevant for a cruise control. Instead it makes more sense in this driving condition to prioritize the detection of the short and medium range since events in this range directly affect the control behavior. For example, in an urban area on a three-lane roadway there could be at a medium distance (e.g. 30 meters) two vehicles on the two outer driving lanes, while the middle driving lane, on which one's own vehicle is located, is free. Then the monitoring of the two preceding vehicles is to be prioritized in order to ensure an optimum control of the longitudinal guidance e.g. if one of the vehicles swings into the lane of the host vehicle. The two targets would therefore have to be categorized as “especially relevant”, and the detection probability may be maximized by adapting the sensor properties to these targets in that e.g. the antenna characteristic is more frequently reshaped to these targets. In this respect, the modulation method is adapted in such a way that the parameters to be assigned to the two targets, that is, distance, relative speed, lateral position, can be detected with a higher detection probability than without the relevant adaptation.

When the driver selects a certain finction of the vehicle, immediately an inference is made to the required tasks of the sensor and an appropriate adaptation of the sensor properties is brought about, e.g. the sensor is adapted completely to the short range if the assistance finction “parking assistant” is selected.

On the other hand, if the vehicle is currently in a critical situation, then by adapting the sensor it is possible to increase the sensitivity in space regions/space cells that are deemed critical, thus in direction and/or distance in order to increase the detection quality of relevant targets.

The position of the vehicle, which may be queried e.g. via the navigation system, can be used for adapting the sensor properties. For this purpose, the information on the digital map may already be divided into categories such as e.g. urban surroundings, country road, expressway and thereby allow for an appropriate configuration of the sensor. The information about these categories of the surroundings in which the vehicle is currently located allow for direct inferences to the sensor properties preferably to be set. For example, when driving on country roads, a range of below 100 meters is sufficient, while in city driving a range of about 50 meters may suffice. The information regarding the vehicle's own movement may be used directly to adapt the required locating field of the sensor.

The installation location of the sensor on the vehicle is another parameter that allows for a suitable configuration. An installation on the side of the vehicle, for example, allows for the conclusion that only tasks of the short-range sensor system are to be performed.

By adapting the individual sensors it is possible to simplify or support the information processing in a central evaluation unit since this now only has to track a small number of targets. For example, when driving at low speed in an urban environment, the tracking of very distant targets may be omitted. This prevents the evaluation unit from being overloaded. Instead, the effort is minimized by adaptation to the relevant objects in the surroundings. In order to be able to increase e.g. the distance resolution up to the centimeter range in the short range, the modulation of the emitted high-frequency signal itself is also designed to be adaptive in the adaptive radar sensor. In a sensor operating in accordance with the FMCW principle, the modulation amplitude itself, for example, is no longer set in a fixed manner, but is rather controlled or adapted dynamically, for example raised in order to increase the distance resolution. To adapt the relative speed resolution, the length of certain frequency ramps is designed to be variable. Furthermore, the shape of the frequency ramps may be designed to be variable or adaptive as a function of certain required properties, e.g. graduated in a linear or in a nonlinear manner. Thus it is possible to utilize the resources of frequency and time, consequently the update rate, in an optimal and functionally adapted manner. Furthermore, the required length of the Fourier transform, e.g. at 265, 512, 1024 or 2048 “bins”, may be adapted to the respective requirements.

The following variables may be used as parameter or information sources for controlled variables or input variables of an adaptation process of the sensor:
the vehicle's own speed;
a detected target scenario; for example, two preceding vehicles side-by-side; center lane free;
a driver assistance finction currently selected by the driver or automatically activated by the vehicle such as e.g. a parking aid or an aid for starting from rest;
critical situations or critical space regions; the absolute position of the vehicle, which is provided via a vehicle navigation system;
surroundings to be expected in the near future, e.g. an intersection, an exit or the like, which is likewise provided via the vehicle navigation system or via a video sensor system, and
the installation location of the sensor on the vehicle.

For performing the adaptation in the sensor, that is, for the actual implementation of the setting of various parameters of the sensor, the following possibilities are used individually or in combination:
the adaptation of the speed resolution, for example, by increasing the resolution by an adaptive elongation of a frequency ramp in the FMCW method, which increases the observation time, or the increase of the sampling rate in a pulse radar;
the adaptation of the distance resolution, for example, by increasing the resolution in the short range by an increase of the frequency deviation in an FMCW radar or by a variation of the pulse length in a pulse radar;
the adaptation of the sampling rate in an analog/digital conversion within the radar sensor or in additional evaluation units;
an adaptation of the length of the fast Fourier transform (FFT) e.g. an increase in the FMCW radar for improved detection in the short range of less than 1 meter;
an adaptation of the integration time in a pulse radar as a finction of the respectively required update rate;
an adaptation of the width or the shape of the antenna characteristic by switching the elements at a high-frequency level or by digital processing in the baseband, for example, by a digital beam shaping by complex-valued weighting of the baseband signals of individual antenna slots.

1.-10. (canceled)

11. A radar sensor for a motor vehicle, comprising:
a transmitting device; and
a receiving device, wherein transmitting parameters of the transmitting device and receiving parameters of the receiving device are variable.

12. The radar sensor as recited in claim 11, wherein:
the transmitting parameters include at least one of:
a transmitting frequency, a transmitting capacity, a modulation
amplitude, and an azimuthal width of an emitted field.

13. The radar sensor as recited in claim 11, wherein:
the receiving parameters include at least one of:
a receiving frequency, a receiving sensitivity, and an
azimuthal width of a received field.

14. A method for controlling transmitting and receiving parameters of a radar sensor, comprising:
changing at least one of the transmitting parameters and the receiving parameters as a function of a driving condition of the motor vehicle.

15. The method as recited in claim 14, the driving condition corresponds to at least one of:
at least one of a speed and an assistance function selected by a driver, and
at least one of a position of the motor vehicle and an installation location of the radar sensor.

16. The method as recited in claim 14, further comprising:
changing a speed resolution of the radar sensor.

17. The method as recited in claim 14, further comprising:
changing a distance resolution of the radar sensor.

18. The method as recited in claim 14, further comprising:
changing a width and a shape of an antenna characteristic.

19. The method as recited in claim 18, wherein the antenna characteristic is changed by switching elements at a high-frequency level.

20. The method as recited in claim 18, wherein the antenna characteristic is changed by digital processing in a baseband.
